(19) United States
(12) Patent Application Publication
(10) Pub. No.: US 2011/0248637 A1
(43) Pub. Date: Oct. 13, 2011

(54) ILLUMINATION DEVICE, LAMP, LIGHTING CIRCUIT, AND ILLUMINATION APPARATUS

(75) Inventors: Kei MITSUYASU, Hirakata-shi (JP); Katunobu Hamamoto, Neyagawa-shi (JP)

(73) Assignee: Panasonic Electric Works Co., Ltd., Osaka (JP)

(21) Appl. No.: 13/075,265

(22) Filed: Mar. 30, 2011

(30) Foreign Application Priority Data
Apr. 9, 2010 (JP) 2010-090734

(51) Int. Cl. H05B 37/02; H05B 37/00

(52) U.S. Cl. 315/178; 315/307; 315/309

(57) ABSTRACT

An illumination device includes a replaceable lamp including at least one light emitting element; a lighting device for lighting the light emitting element by supplying a power to the lamp; and an illuminance correction unit for performing a dimming control on the lamp. The illuminance correction unit includes a timer for counting a cumulative lighting time of the light emitting element and a memory for storing the cumulative lighting time counted by the timer. The illuminance correction unit determines a dimming ratio of the light emitting element based on the cumulative lighting time stored in the memory and an illuminance correction characteristic, in which the relationship between the cumulative lighting time and the dimming ratio of the light emitting element is determined to uniformly maintain a light output from the light emitting element even when the cumulative lighting time increases. The memory is provided in the lamp.

### FIELD OF THE INVENTION

The present invention relates to an illumination device, a lamp, a lighting circuit, and an illumination apparatus that are capable of maintaining the light output from a lamp uniformly in spite of the cumulative lighting time being increased.

### BACKGROUND OF THE INVENTION

In order to compensate for a reduction in light output resulting from aging of a fluorescent lamp or contamination attributable to long-term use, there has been disclosed an illumination device configured to cumulatively count a lighting time after a replacement of a fluorescent lamp and perform a dimming control so that the dimming ratio can increase in proportion to an increase in the cumulative lighting time. This type of illumination device can prevent the light output from being reduced by aging degradation by, for example, setting an initial value of the dimming ratio to 70% of a rating and gradually increasing the dimming ratio as the cumulative lighting time increases, thereby maintaining the light output from the fluorescent lamp substantially uniformly.

Furthermore, recently, illumination devices which use light emitting elements, such as Light-Emitting Diodes (LEDs), as lamps, instead of fluorescent lamps, have been provided. This type of illumination devices usually experience a reduction in luminous flux resulting from the degradation of phosphor or resin used in the light emitting elements. Among this type of illumination devices, there have been provided illumination devices light outputs of which can be prevented from being reduced in spite of increases in the cumulative lighting time by increasing the dimming ratio in proportion to an increase in the cumulative lighting time (see, e.g., Japanese Patent Application Publication No. 2008-041650)

Furthermore, there has been proposed an illumination device which is configured to, when an old lamp is replaced with a new one, detect a termination of the lifespan of the lamp or a detachment of the lamp and automatically reset the cumulative lighting time, thereby restoring the dimming ratio to an initial value (see, e.g., Japanese Patent Application Publication No. 2001-015276 (JP2001-015276A1)).

However, the illumination device described in JP2001-015276A1 requires a complicated control method for determining a replacement of a lamp in order to reliably restore the dimming ratio to an initial value when the lamp is replaced, which causes an increase in cost.

Furthermore, when the lamp is a fluorescent lamp, the lamp comes into an emission state (i.e., a state where filament emission is reduced significantly) and is thus in a half-wave discharging state, so that it is possible to detect the end of the life span of the lamp in the form of an electrical characteristic. In contrast, when one or more light emitting elements, such as one or more LEDs, are used as the lamp, it is difficult to detect the end of the life span of the lamp in the form of an electrical characteristic and it is more difficult to determine whether the lamp has been replaced.

If it is difficult for the illumination device to determine whether a lamp has been replaced, it cannot reset the cumulative lighting time. Accordingly, the illumination device cannot light a new lamp at an appropriate dimming ratio and, thus, it cannot maintain the light output from the lamp uniformly.

### SUMMARY OF THE INVENTION

In view of the above, the present invention provides an illumination device, a lamp, a lighting circuit, and an illumination apparatus that can reliably reset the cumulative lighting time of a lamp when the lamp is replaced.

In accordance with an aspect of the present invention, there is provided an illumination device including a replaceable lamp including at least one light emitting element; a lighting device for lighting the light emitting element by supplying a power to the lamp; and an illuminance correction unit for performing a dimming control on the lamp. The illuminance correction unit includes a timer for counting a cumulative lighting time of the light emitting element and a memory for storing the cumulative lighting time counted by the timer. The illuminance correction unit determines a dimming ratio of the light emitting element based on the cumulative lighting time stored in the memory and an illuminance correction characteristic, in which the relationship between the cumulative lighting time and the dimming ratio of the light emitting element is determined to uniformly maintain a light output from the light emitting element even when the cumulative lighting time of the light emitting element increases. The memory is provided in the lamp.

Preferably, the timer may be provided in the lamp.

Preferably, the illuminance correction unit may include an output stopping unit which provides an instruction to the lighting device to stop supplying the power to the lamp when the cumulative lighting time of the light emitting element exceeds a threshold.

Preferably, the illuminance correction unit may include a temperature measurement unit for measuring a surrounding temperature of the lamp, and determines the illuminance correction characteristic depending on the surrounding temperature measured by the temperature measurement unit.

Preferably, the lighting device may include a flyback converter and applies an output voltage of the flyback converter to the lamp.

Preferably, the lighting device may include a step-down chopper circuit and applies an output voltage of the step-down chopper circuit to the lamp.

In accordance with another aspect of the present invention, there is provided a lamp for sued with the illumination device.

In accordance with still another aspect of the present invention, there is provided a lighting circuit included in the illumination device along with the lamp. The lighting circuit comprises a switching power source and is configured to switch between a first operation mode in which a connected first lamp formed of the lamp set forth in claim 7 is lit and a second operation mode in which a connected second lamp formed of a fluorescent lamp is lit, and parts of elements of the switching power source are commonly used both in the first operation mode and in the second operation mode.

In accordance with still another aspect of the present invention, there is provided an illumination apparatus including the lighting circuit. Both of the first lamp and the second lamp are usable with the illuminance apparatus.

In accordance with the present invention, it is possible to reliably reset the cumulative lighting time of a lamp when the lamp is replaced.

### BRIEF DESCRIPTION OF THE DRAWINGS

The objects and features of the present invention will become apparent from the following description of embodiments, given in conjunction with the accompanying drawings, in which:

FIG. 1 is a schematic block diagram showing a basic configuration of an illumination device in accordance with a first embodiment of the present invention;

FIG. 2 is a schematic circuit diagram showing a configuration of the illumination device;

FIG. 3 is a schematic perspective view showing an outer appearance of a lamp in accordance with the first embodiment;

FIG. 4 is a schematic circuit diagram showing a configuration of an illuminance correction unit in accordance with the first embodiment;

FIG. 5 is a graph illustrating illuminance correction characteristics in accordance with the first embodiment;

FIG. 6 is a schematic perspective view showing an illumination apparatus in accordance with the first embodiment 1;

FIG. 7 is a schematic circuit diagram showing a modification of the illumination device;

FIG. 8 is a schematic circuit diagram showing another modification of the illumination device;

FIG. 9 is a schematic circuit diagram showing still another modification of the illumination device;

FIG. 10 is a schematic circuit diagram showing a configuration of an illumination device in accordance with a second embodiment;

FIG. 11 is a schematic circuit diagram showing a modification of the illumination device; and

FIG. 12 is a schematic circuit diagram showing a configuration of an illumination device in accordance with a third embodiment.

### DETAILED DESCRIPTION OF THE EMBODIMENTS

Embodiments of the present invention will now be described with reference to the accompanying drawings which form a part hereof. Further, in the following description and drawings, components having substantially the same configuration and function are denoted by like reference characters, and thus redundant description thereof will be omitted herein.

### First Embodiment

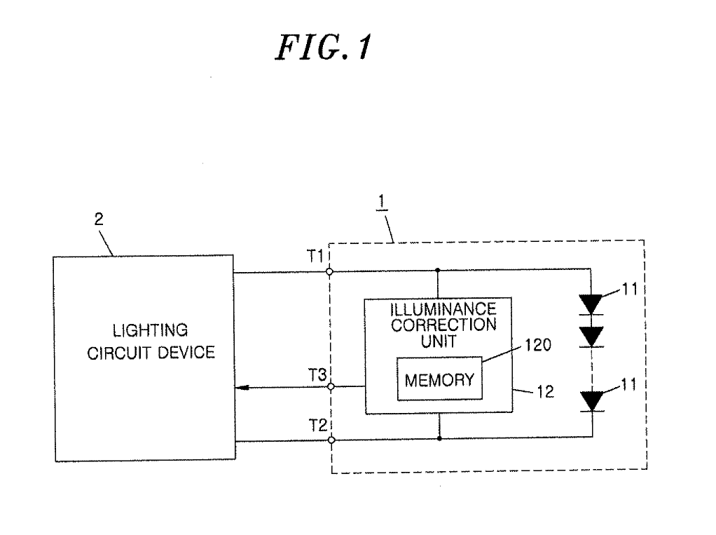

An illumination device in accordance with a first embodiment of the present invention includes a lamp 1 and a lighting circuit 2, as illustrated in FIG. 1. The lamp 1 is configured to be replaceable and includes one or more light emitting elements 11.

The lighting circuit 2 includes a lighting device including a flyback DC-DC converter, and causes the lamp 1 to be lit by supplying a power to the light emitting elements 11 provided inside the lamp 1 as well as the lighting device. The lamp 1 further includes an illuminance correction unit 12 having a memory 120, in addition to the light emitting elements 11, which will be described in detail later. Here, the term “light emitting element” refers to an element which receives a power and then emits light, such as a Light-Emitting Diode (LED) or an organic Electroluminescent (EL) device. In the present embodiment, LEDs are used as the light emitting elements 11.

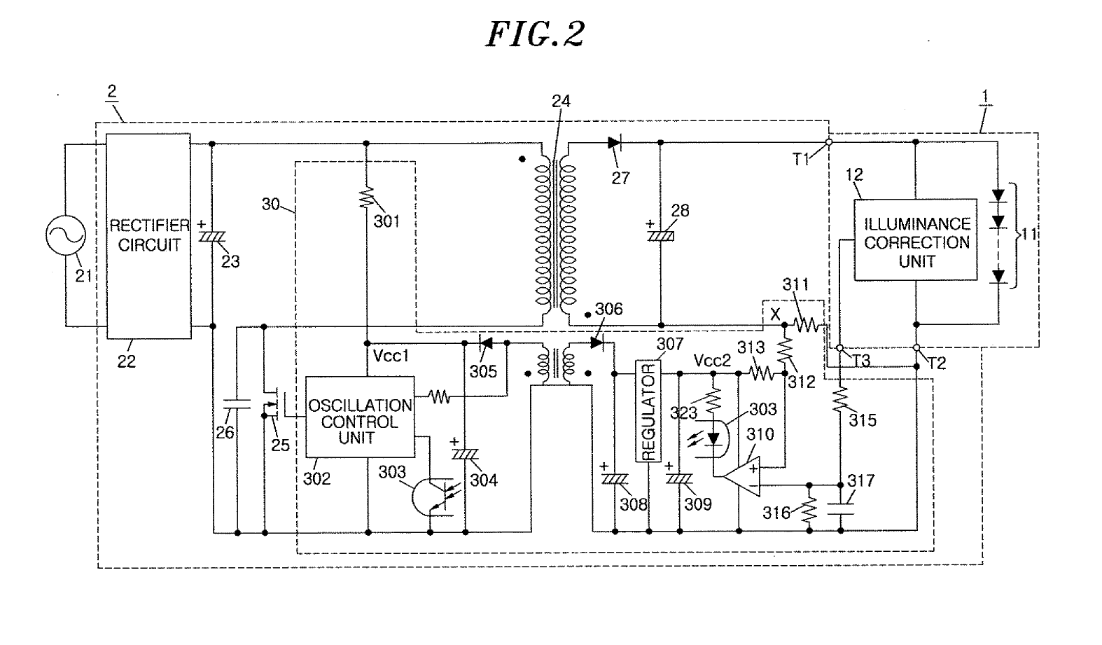

The lighting circuit 2, as shown in FIG. 2, includes a rectifier circuit 22 for rectifying an input from a commercial power source 21 and a smoothing capacitor 23 for smoothing an output voltage of the rectifier circuit 22. Directly connected to the smoothing capacitor 23 is a switching device 25 including a primary coil of a transformer 24 and a Metal-Oxide Semiconductor Field-Effect Transistor (MOSFET). A capacitor 26 is connected in parallel to the switching device 25.

The capacitor 26 serves to reduce the switching loss in the switching device 25 and improve circuit efficiency.

The lighting circuit 2 generates a high-frequency AC voltage by alternately turning on and off the switching device 25 by the control circuit 30, and applies an AC voltage to the primary coil of the transformer 24. The lighting circuit 2 obtains a DC voltage by converting the AC voltage by the transformer 24 and smoothing the converted voltage by a rectifier diode 27 and a smoothing capacitor 28 provided in a secondary coil of the transformer 24. The lighting circuit 2 applies such DC voltage (voltage between opposite ends of the smoothing capacitor 28) to the lamp 1.

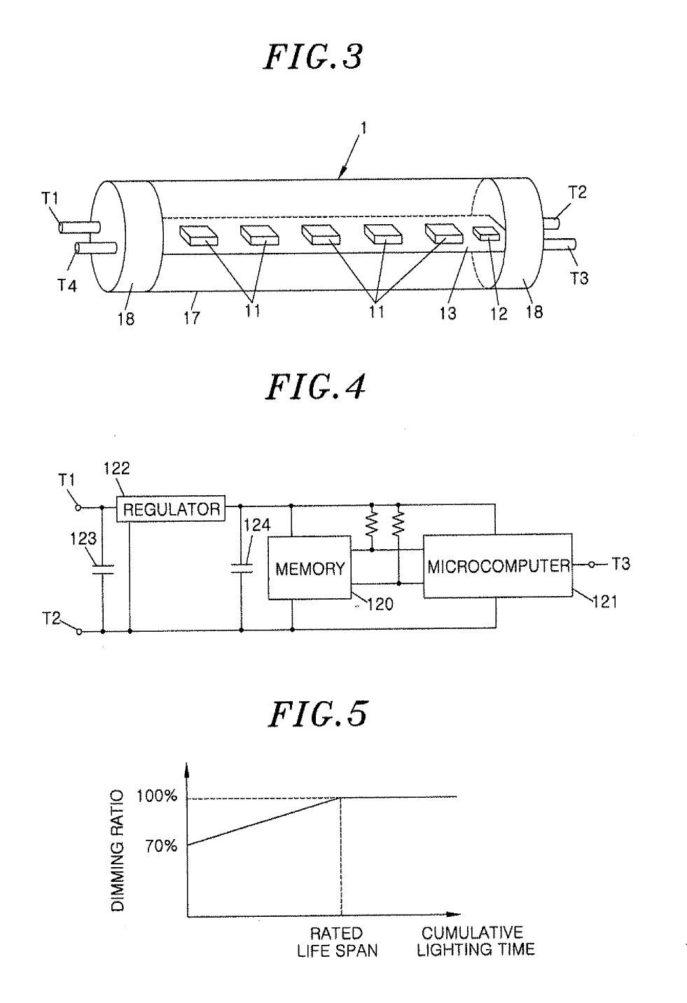

The lamp 1 has an outer appearance that is substantially identical to an outer appearance of a straight tube-shaped luminescent lamp, as exemplified in FIG. 3. That is, the lamp 1 includes a cylindrical tube 17 made of a transparent material and bases 18 respectively disposed at opposite ends of the tube 17 in the longitudinal direction of the tube 17. A mounting substrate 13 on which a plurality of light emitting elements 11 is mounted is accommodated in the tube 17, and the bases 18 are electrically connected to the mounting substrate 13. In the present embodiment, the mounting substrate 13 has a thin, longitudinal rectangular shape extending along the longitudinal direction of the tube 17, and the light emitting elements 11 are arranged in a line along the longitudinal direction of the mounting substrate 13. The light emitting elements 11 are connected in series, and are lighted by applying a voltage from the lighting circuit 2 to the mounting substrate 13 through the bases 18.

Furthermore, the illuminance correction unit 12 connected in parallel to a series circuit of the light emitting elements 11 is mounted on the mounting substrate 13. The illuminance correction unit 12, as shown in FIG. 4, includes a microcomputer 121 functioning as a timer for counting a cumulative lighting time of the light emitting elements 11, a nonvolatile memory 120 for storing the cumulative lighting time, and a regulator 122 for applying a stable power-supply voltage to the microcomputer 121 and the nonvolatile memory 120. The illuminance correction unit 12 includes a capacitor 123 connected between input terminals of the regulator 122 and a capacitor 124 connected between output terminals of the regulator 122. Terminals T1, T2 and T3 shown in FIG. 4 correspond to terminals T1, T2 and T3 shown in FIG. 3, respectively. Meanwhile, a terminal T4 shown in FIG. 3 is provided to hold the lamp 1 in the socket of an illumination apparatus, and may be omitted because it is free of electricity.

The microcomputer 121 reads out data related to the cumulative lighting time stored in the memory 120 when a voltage is applied from the lighting circuit 2 to the lamp 1 and an output voltage of the regulator 122 has reached a predetermined stable voltage. Thereafter, the microcomputer 121 counts the time period during which the voltage is applied to the lamp 1, adds the counted value to a first read-out cumulative lighting time, and updates the data related to the cumulative lighting time. The updated data is regularly backed up in the memory 120, and backed-up data is finally stored in the memory 120 when the supply of a power to the lamp 1 is cut off. In this way, the microcomputer 121 reads out the data related to the cumulative lighting time stored in the memory 120 when the supply of a power to the lamp 1 is resumed, and resumes counting the cumulative lighting time from that time.

In the microcomputer 121, illuminance correction characteristics have been set based on luminous flux decline characteristics indicative of a decline in luminous flux resulting from an increase in the cumulative lighting time of the light emitting elements 11. The illuminance correction characteristics indicate relationships between the dimming ratio as an illuminance correction value and the cumulative lighting time, and are set such that the light output from the light emitting elements 11 are maintained uniformly, even when the cumulative lighting time of the light emitting elements 11 increases.

In the present embodiment, in case the rated dimming ratio is set to an initial value of 70%, the illuminance correction characteristics gradually increase the dimming ratio as the cumulative lighting time increases, until the dimming ratio reaches 100% at the point of time when the rated life span of the lamp 1 is reached. Thereafter, the illuminance correction characteristics maintain the dimming ratio of 100%, as shown in FIG. 5. The microcomputer 121 starts to instruct the lighting circuit 2 to light the light emitting elements 11 at a dimming ratio corresponding to the value of the counted cumulative lighting time by using such illuminance correction characteristics. Furthermore, the illuminance correction characteristics as well as the cumulative lighting time may be stored in the memory 120 or a different memory.

However, the above case is merely an example. The rated dimming ratio may be set to another initial value of, e.g., 80%. Further, it is not necessary that the dimming ratio reaches 100% at the point of time when the rated life span of the lamp 1 is reached.

In greater detail, the microcomputer 121 of the illuminance correction unit 12 sets a target value of the dimming ratio by using the illuminance correction characteristics. The illuminance correction unit 12 converts the target value of the dimming ratio into a Pulse Width Modulation (PWM) signal in consideration of the relationship between a current flowing through the light emitting elements 11 and luminous flux and then outputs it via the terminal T3 of the lamp 1. That is, the illuminance correction unit 12 changes the duty ratio of a PWM signal in accordance with the target value of the dimming ratio. In the present embodiment, as the target value of the dimming ratio increases due to an increase in the cumulative lighting time, the duty ratio of the PWM signal is set to be smaller.

The lighting circuit 2 converts the PWM signal output from the lamp 1 into a DC voltage by using the smoothing circuit including resistors 315 and 316 and a capacitor 317, and sets the DC voltage as the reference voltage of a comparator 310. That is, the smoothing circuit applies the DC voltage, the magnitude of which is determined depending on the duty ratio of the PWM signal, to the inverting input terminal of the comparator 310 as a reference voltage, and reduces the reference voltage in proportion to a reduction in the duty ratio of the PWM signal.

Meanwhile, the luminous flux increases in proportion to an increase in the current flowing through the light emitting elements 11. Accordingly, the lighting circuit detects the dimming ratio of the light emitting elements 11 by detecting the current flowing through the light emitting elements 11 by use of a resistor 311 inserted between the terminal T2 of the lamp 1 and the secondary coil of the transformer 24. As the current flowing through the light emitting elements 11 increase, the voltage drop over the resistor 311 increases. Further, the electric potential at the detection point “X” (a junction between the resistor 311 and the secondary coil of the transformer 24) shown in FIG. 2 is decreased.

Furthermore, a DC bias is applied to the detection point “X” from a DC voltage Vcc2 (which will be described later) generated at a secondary coil of the control circuit 30 via the resistors 313 and 312, and a junction between the resistor 313 and the resistor 312 is connected to a non-inverting input terminal of the comparator 310. Accordingly, as the electric potential at the detection point “X” decreases, a voltage (hereinafter referred to as the “detected voltage”) applied to the non-inverting input terminal of the comparator 310 decreases. The comparator 310 can determine the magnitude relationship between the dimming ratio of the light emitting elements 11 and the target value by comparing the detected voltage with the reference voltage.

The control circuit 30 is operated by using the DC voltage Vcc2 as its power supply voltage. The DC voltage Vcc2 can be obtained by smoothing the AC voltage, which can be obtained from the secondary coil of the transformer 24, by use of a diode 306 and a capacitor 308 and stabilizing a voltage applied between opposite ends of the capacitor 308 by use of a regulator 307.

An output from the regulator 307 is connected to an output terminal of the comparator 310 via a resistor 323 and an LED of a photocoupler 303. When the dimming ratio of the light emitting elements 11 is greater than the target value, the detected voltage of the comparator 310 is lower than the reference voltage, so that an output from the comparator 310 becomes a low level and a current flows through the LED of the photocoupler 303. In contrast, when the dimming ratio is smaller than the target value, no current flows through the LED of the photocoupler 303. A phototransistor of the photocoupler 303 will be described later.

Next, the switching control of the switching device 25 will now be described. The switching device 25 is controlled to be turned on and off by an oscillation control circuit 302. The oscillation control circuit 302 is operated by using a DC voltage Vcc1, applied from the smoothing capacitor 23 via a starting resistor 301, as its power supply voltage in an interval between a time when the lighting circuit 2 inputs a power and a time when the switching device 25 starts to be oscillated. After the switching device 25 has started to be oscillated, the oscillation control circuit 302 is operated by using the DC voltage Vcc1, obtained by smoothing an AC voltage, which can be obtained from the secondary coil of the transformer 24, by use of a diode 305 and a capacitor 304, as its power supply voltage.

The oscillation control circuit 302 generates triangle waves by charging a capacitor (not shown) from a current source (not shown) provided therein, and compares the voltage value of these triangle waves with a determination threshold value as a reference. The oscillation control circuit 302 turns on the switching device 25 by outputting a drive signal to the switching device 25 until the voltage value of the triangle waves reaches the determination threshold value. That is, while the voltage value of the triangle waves is greater than the determination threshold value, the switching device 25 is turned off.

The oscillation control circuit 302 is connected to a phototransistor of the photocoupler 303, and is configured such that the determination threshold value is decreased when the phototransistor is turned on and the determination threshold value is increased when the phototransistor is turned off. Accordingly, when the dimming ratio is greater than the target value, a current flows through the LED of the photocoupler 303, so that the phototransistor is turned on and the determination threshold value is decreased. For that reason, an on-period during which the switching device 25 is turned on is decreased and the voltage applied to the light emitting elements 11 is decreased, so that the dimming ratio is decreased.

In contrast, when the dimming ratio is smaller than the target value, the on-period during which the switching device 25 is turned on is increased, so that the dimming ratio of the light emitting elements 11 is increased, with the result that the dimming ratio is feedback-controlled to be close to the target value.

With the above-described configuration, the illuminance correction unit 12 decreases the current flowing through the light emitting elements 11 by increasing the reference voltage of the comparator 310 in the early stage of lighting the lamp 1, and increases the current of the light emitting elements 11 by decreasing the reference voltage as the cumulative lighting time increases. That is, based on the illuminance correction characteristics shown in FIG. 5, the illuminance correction unit 12 increases the dimming ratio by increasing the current flowing through the light emitting elements 11 as the cumulative lighting time of the light emitting elements 11 increases, thereby maintaining the light output from the light emitting elements 11 to be substantially uniform.

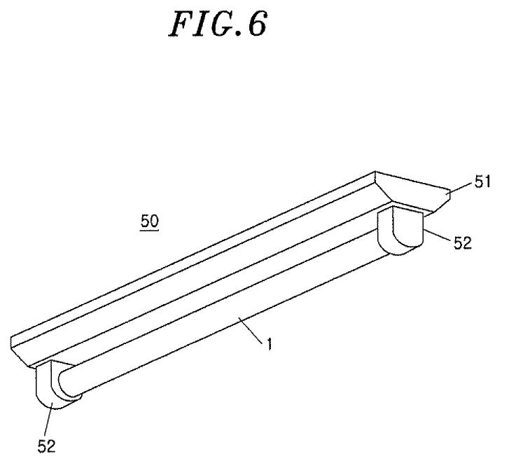

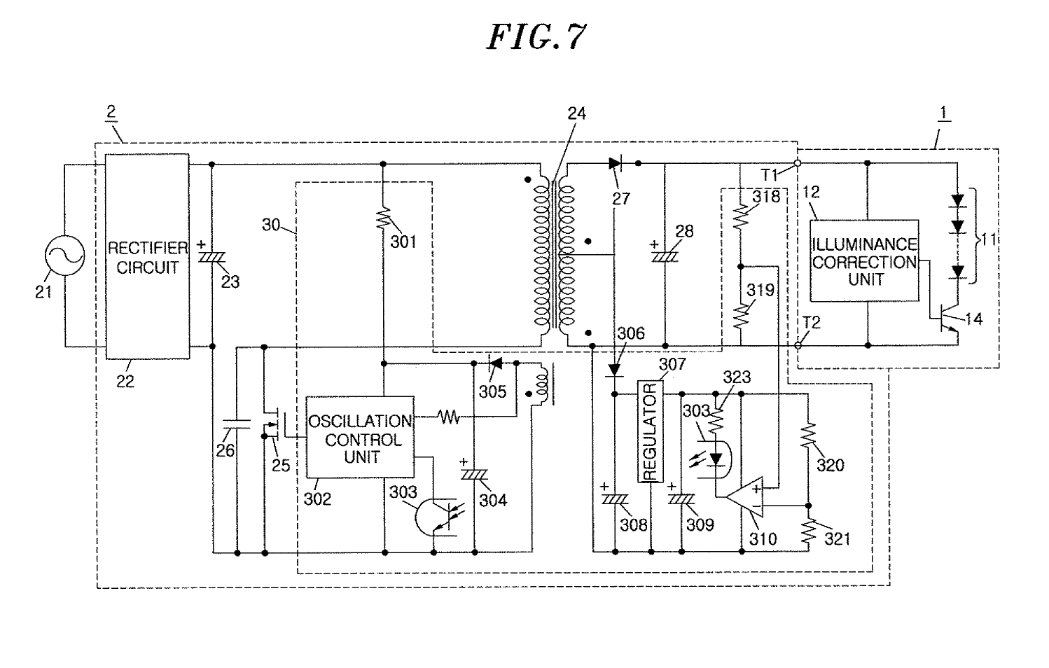

FIG. 6 shows an example of an outer appearance of an illumination apparatus 50 which includes an illumination device containing the above-described lamp 1 and lighting circuit 2. The lighting circuit 2 is accommodated in a housing 51 of the illumination apparatus 50, and is electrically connected to a pair of two sockets 52 which are fastened to the housing 51. The two sockets 52 are formed to correspond to the bases 18 of the straight tubular lamp 1 so that they can be connected to the terminals T1 and T4, and T2 and T3 of the lamp 1 shown in FIG. 3, and are arranged to correspond to those of the bases 18. Accordingly, the lamp 1 is fitted into the sockets 52, so that it is electrically connected to the lighting circuit 2 and is held by the housing 51 of the illumination apparatus 50. With such structure, it is possible to continuously use the illumination apparatus 50 by replacing only the lamp 1.

In accordance with the illumination device configured as described above, the memory 120 of the illuminance correction unit 12 is contained in the lamp 1. Accordingly, when the lamp 1 is replaced due to the termination of its lifespan, its damage or the like, the lamp 1 is replaced for each memory 120 which stores the cumulative lighting time of the light emitting elements 11. That is, after the replacement of the lamp 1, the illuminance correction unit 12 can reset the cumulative lighting time in the memory 120 and thus restore the dimming ratio, i.e., an illuminance correction value, to the initial value without performing complicated control to determine whether the lamp 1 has been replaced. As a result, the illuminance correction unit 12 can perform the illuminance correction appropriate for a new lamp 1.

Furthermore, the lighting circuit 2 serves to maintain the light output from the lamp 1 to be uniform even when the cumulative lighting time increases generally. Further, the lighting circuit 2 has illuminance correction characteristics which are set based on the previously stored luminous flux decline characteristics of a lamp. Accordingly, when the lamp 1 is replaced with a different type of lamp 1 having different luminous flux decline characteristics, such as a lamp 1 with a different color of light, some problem is caused by the difference between the luminous flux and the predetermined target value which is gradually increased as the lighting time increases.

However, with the configuration of the present embodiment, the microcomputer 121 in which the illuminance correction characteristics have been set is provided in the lamp 1, so that the illuminance correction can be conducted by using illuminance correction characteristics appropriate for the type of lamp 1. Accordingly, the lighting circuit 2 can light the lamp 1 at a brightness level appropriate for the type of lamp 1.

Furthermore, by installing the flyback converter in the lighting device, it is possible to convert an input voltage supplied from a commercial power source 21 into a DC voltage at high efficiency and then applying the DC voltage to the lamp 1. In the present embodiment, the lighting device is a device for supplying a power to the lamp 1 and lighting the light emitting elements 11, and is a part in which the control circuit 30 has been excluded from the lighting circuit 2.

However, in accordance with a modification of the present embodiment, the illumination device may be configured such that a switch element 14 for controlling the output of the light emitting elements 11 is contained in a lamp 1, as shown in FIG. 7. The switch element 14 shown in FIG. 7 includes an npn transistor, and is connected in series to the light emitting elements 11. The illuminance correction unit 12 is connected in parallel to the series circuit of the light emitting elements 11 and the switch element 14, and an output terminal of the illuminance correction unit 12 is connected to a control terminal (base) of the switch element 14.

In the configuration shown in FIG. 7, the illuminance correction unit 12 outputs a PWM signal, the duty ratio of which increases as the target value of the dimming ratio is increased, to the switch element 14. The switch element 14 is alternately turned on and off depending on the PWM signal. In the present embodiment, in proportion to a reduction in the on-period during which the switch element 14 is turned on and which is determined depending on the duty ratio of the PWM signal, the output of the light emitting elements 11 is decreased and, therefore, the dimming ratio is decreased. In this case, the duty ratio of the PWM signal is substantially proportional to the dimming ratio. Accordingly, the illuminance correction unit 12 may set the target value of the dimming ratio, and then output a PWM signal, the duty ratio of which is set as the target value, to the switch element 14, thereby simplifying the illuminance correction control.

Furthermore, in the configuration shown in FIG. 7, the illuminance correction unit 12 performs the control of the dimming ratio inside the lamp 1, so that it is not necessary to output a PWM signal from the terminal T3 to the lighting circuit 2 and the lighting circuit 2 merely needs to apply a uniform DC voltage to the lamp 1.

Therefore, the control circuit 30 includes a series circuit of resistors 318 and 319 between terminals T1 and T2, that is, the output terminals of the lighting circuit 2, and a series circuit of resistors 320 and 321, to opposite ends of which DC voltage Vcc2 is applied. A junction between the resistors 318 and 319 is connected to a non-inverting input terminal of the comparator 310, and a junction between the resistors 320 and 321 is connected to an inverting input terminal of the comparator 310.

The comparator 310 compares the voltage, i.e., the detected voltage, obtained by the voltage division of the resistors 318 and 319 with a reference voltage obtained by the voltage division of the resistors 320 and 321. The lighting circuit 2 performs a feedback control so that a voltage applied to the lamp 1 is kept uniform in such a way as to determine the on-period of the switching device 25 based on an output from the comparator 310 by using the oscillation control circuit 302.

The configuration shown in FIG. 7 has the advantage in simplifying the configuration of the illumination device, compared to the configuration shown in FIG. 2.

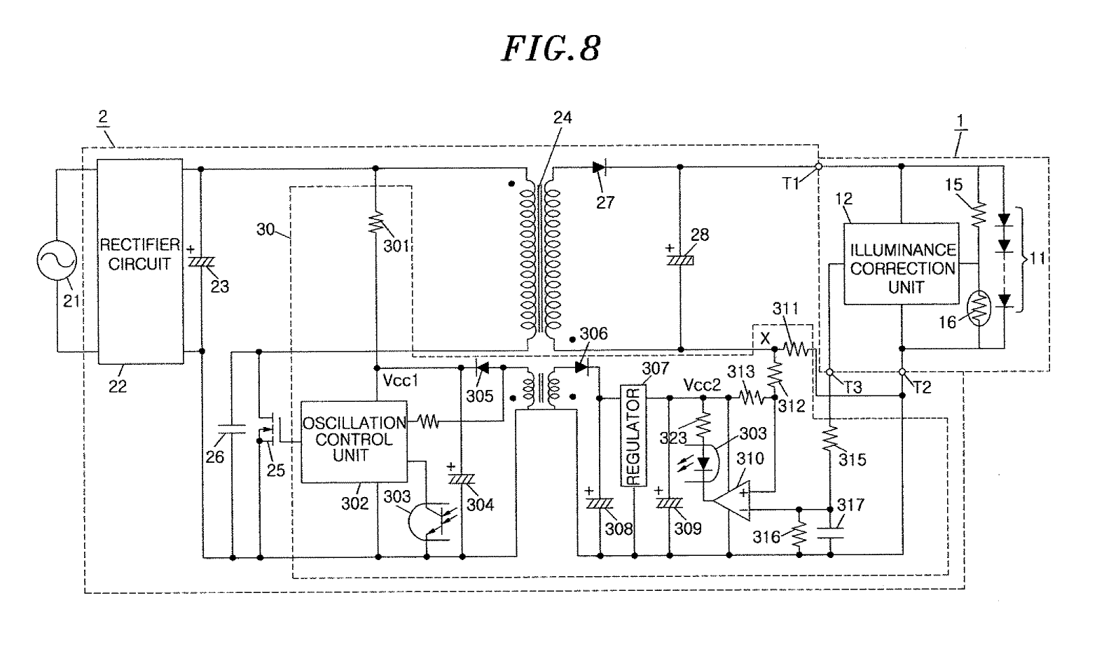

Furthermore, the illumination device of the present embodiment may be configured such that a temperature measurement unit 16 for measuring a surrounding temperature of the lamp 1 is further included in the lamp 1, as shown in FIG. 8. This temperature measurement unit 16, the memory 120 and the microcomputer 121 constitutes the illuminance correction unit.

That is, it has been commonly known that the luminous flux decline characteristics of the light emitting elements 11 are significantly changed by the surrounding temperature. This results from a reduction in light emission efficiency which is attributable to, in the case where the light emitting elements 11 are LEDs, for example, the degradation of phosphor included in synthetic resin which covers an LED chip or the degradation of a resin which is used as a reflective plate. That is, as the surrounding temperature increases, the degradation of the resin speeds up and, thus, the light emission efficiency becomes lower.

Since the surrounding temperature and the luminous flux decline characteristics are varied depending on the location of attachment of the lamp 1, the illuminance correction unit 12 having the configuration shown in FIG. 8 corrects the dimming ratio by using the measurement results of the temperature measurement unit 16 such that the light output from the lamp 1 can be maintained to be uniform in spite of variations in the surrounding temperature. In greater detail, the illuminance correction unit 12 is configured to store luminous flux decline characteristics for each surrounding temperature in the memory 120 in advance and then adjust illuminance correction characteristics to be used in accordance with the measurement value of the temperature measurement unit 16.

In the configuration shown in FIG. 8, the temperature measurement unit 16 including a Negative Temperature Coefficient (NTC) thermistor is provided in the lamp 1. The temperature measurement unit 16 and the resistor 15 are connected in series between the terminals T1 and T2 of the lamp 1, and the output voltage of the lighting circuit 2 is divided by the series circuit of the temperature measurement unit 16 and the resistor 15. That is, when the surrounding temperature of the lamp 1 increases, the resistance of the temperature measurement unit 16 is decreased, with the result that a voltage applied between opposite ends of the temperature measurement unit 16 is decreased.

The illuminance correction unit 12 determines the surrounding temperature of the lamp 1 by receiving the voltage applied between opposite ends of the temperature measurement unit 16, and selects luminous flux decline characteristics corresponding to the relevant temperature from a plurality of luminous flux decline characteristics for respective temperatures stored in the memory 120 in advance. The illuminance correction unit 12 determines illuminance correction characteristics based on the selected luminous flux decline characteristics, and determines the dimming ratio corresponding to the cumulative lighting time of the lamp 1 by using these illuminance correction characteristics.

As described above, in accordance with the illumination device configured such that the temperature measurement unit 16 is further included in the lamp 1, it is possible to maintain the luminous flux almost to be uniform by compensating for variations in temperature, even when the surrounding temperature of the lamp 1 varies due to a location where the lamp 1 is disposed. Furthermore, although the example of using an NTC thermistor as the temperature measurement unit 16 has been described in the present embodiment, the temperature measurement unit 16 is not limited thereto, and an element capable of measuring the surrounding temperature as an electrical characteristic may be used as the temperature measurement unit 16. For example, the temperature measurement unit may measure the surrounding temperature of the lamp 1 by using the forward-voltage temperature characteristics of the light emitting elements 11.

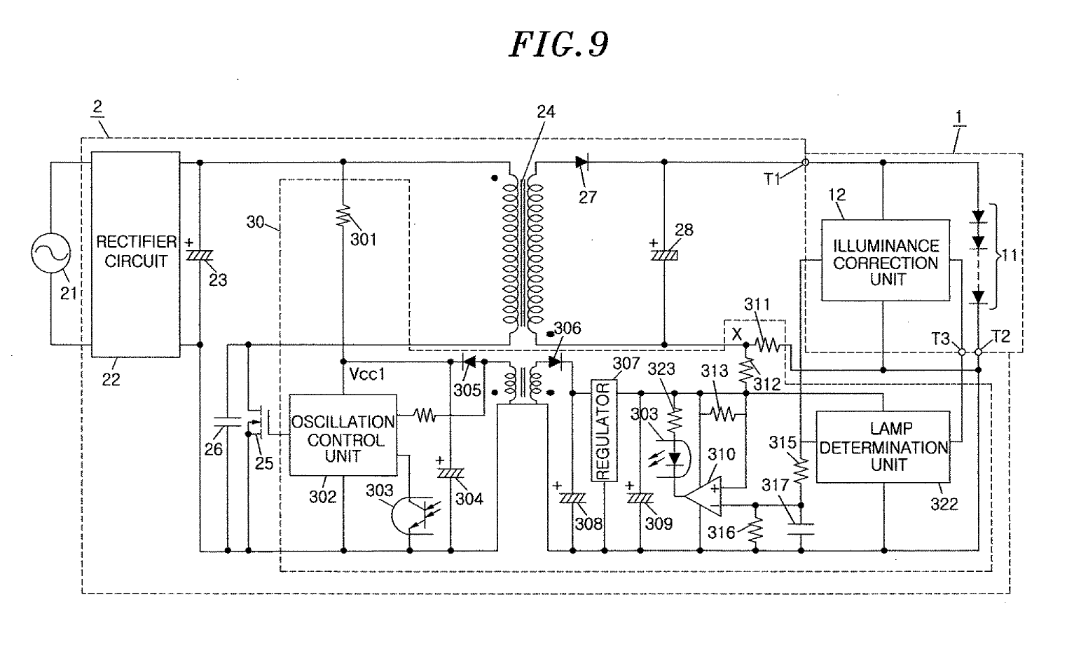

Furthermore, in accordance with another modification of the present embodiment, an illumination device may be configured such that a lamp determination unit 322 is provided in the control circuit 30 of the lighting circuit 2, as shown in FIG. 9.

Specifically, when the lifespan of the lamp 1 has expired and then the lamp 1 is replaced with a new lamp 1 in the case where the memory 120 and the microcomputer 121 are provided in the lamp 1, microcomputers are required for the old and new lamps 1, respectively, which is the cause of an increase in the cost of the lamp 1.

In contrast, in the configuration of FIG. 9, the microcomputer 121 is omitted from the inside of the lamp 1 and, instead, the lamp determination unit 322 for counting the cumulative lighting time of the lamp 1 is provided in the lighting circuit 2. The lamp determination unit 322 is operated by applying the DC voltage Vcc2, and is connected between the terminal T3 of the illuminance correction unit 12 and the resistor 315. That is, the output of the lamp determination unit 322 is inputted to the inverting input terminal of the comparator 310 via the resistor 315.

The lamp determination unit 322 basically has the same functionality as the microcomputer 121 shown in FIG. 4. That is, the lamp determination unit 322 functions as a timer for counting the cumulative lighting time of the light emitting elements 11, and constitutes an illuminance correction unit along with memory 120 in the lamp 1. Furthermore, the lamp determination unit 322 has illuminance correction characteristics set based on the luminous flux decline characteristics of the light emitting elements 11, and determines the target value of the dimming ratio corresponding to the value of the counted cumulative lighting time by using these illuminance correction characteristics.

In greater detail, when the lamp 1 starts to be lighted, the lamp determination unit 322 reads out the cumulative lighting time from the memory 120 of the lamp 1, and determines the target value of the dimming ratio based on the cumulative lighting time by updating the count and data of the cumulative lighting time. The lamp determination unit 322 outputs a PWM signal corresponding to the target value of the dimming ratio, which is converted into a DC voltage by using the resistors 315 and 316 and the capacitor 317 and is inputted to the comparator 310 as a reference voltage. Accordingly, at the early stage of lighting, the reference voltage of the comparator 310 is increased, so that the current flowing through the light emitting elements 11 is decreased. Thereafter, as the cumulative lighting time increases, the reference voltage is decreased, so that the current of the light emitting elements 11 is gradually increased.

In accordance with the illumination device having the configuration shown in FIG. 4, the memory 120 is preferably provided in the lamp 1 and the microcomputer 121 may be omitted. Accordingly, the cost of the lamp 1 can be kept low and this effect shows up more significantly in places, such as an office, where a plurality of lamps 1 is used.

Furthermore, even when, for example, the lamp 1 is replaced with a lamp having different luminous flux decline characteristics such as a lamp 1 with a different color of light, it is possible to perform the illuminance correction appropriate for the lamp 1 by storing the luminous flux decline characteristics of a plurality of types of lamps 1 in the lamp determination unit 322.

Specifically, when identification data indicative of the types of lamp is stored in the memory 120, the lamp determination unit 322 can identify the type of lamp 1 based on the identification data and determine luminous flux decline characteristics based on identification results. Further the illuminance correction can be conducted by using appropriate illuminance correction characteristics. Accordingly, it is possible to light the lamp 1 at a brightness level appropriate for the type of lamp 1 by providing the lamp 1 with the memory 120 even when the microcomputer 121 is omitted from the lamp 1.

Although, in the present embodiment, the lamp 1 is configured such that the light emitting element 11 and the illuminance correction unit 12 are connected in parallel between the terminals T1 and T2, the lamp 1 is not limited to this configuration, but may have any configuration in which a predetermined DC voltage is applied to the illuminance correction unit 12. For example, the illuminance correction unit 12 may be connected in parallel to some of a plurality of light emitting elements 11 which are connected in series to each other.

### Second Embodiment

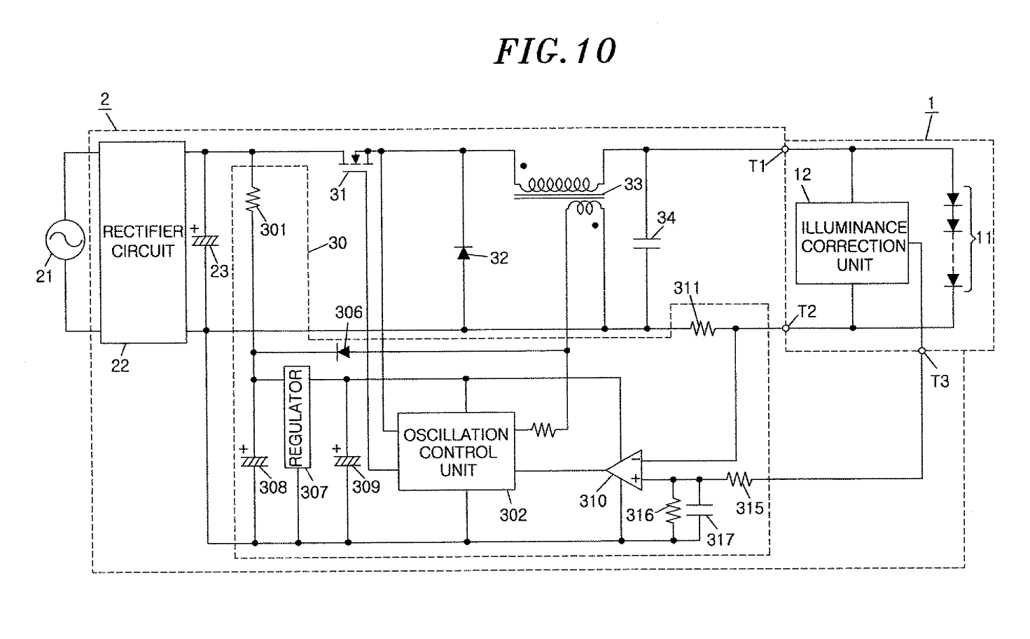

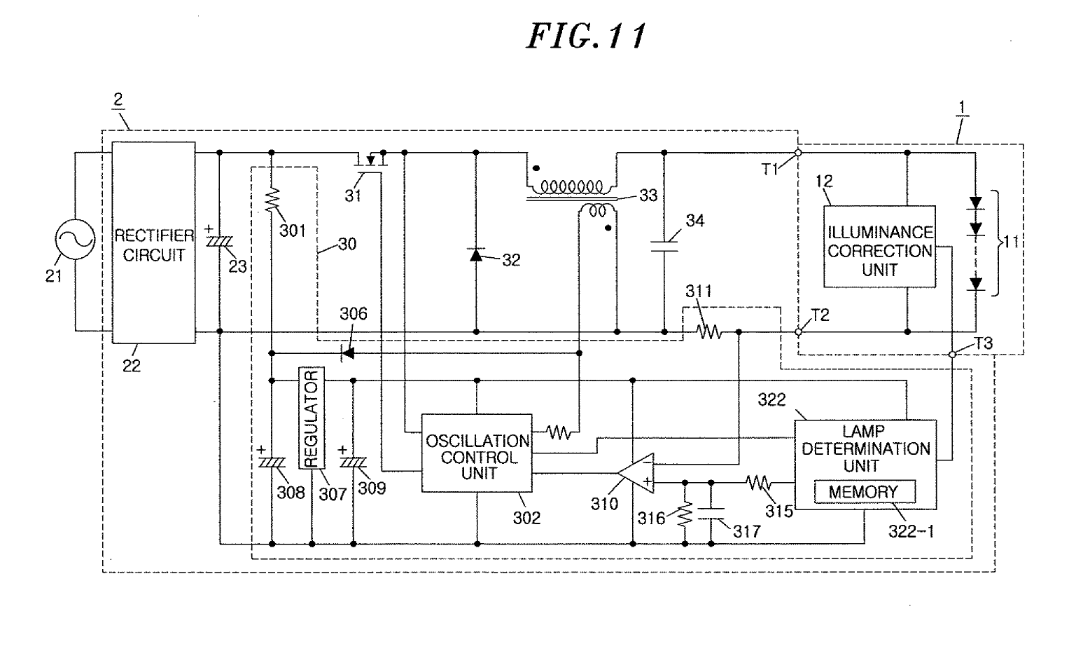

An illumination device in accordance with a second embodiment is different from the illumination device of the first embodiment in that a step-down chopper type converter (step-down chopper circuit) is used in the lighting device of a lighting circuit 2, as shown in FIG. 10. Accordingly, descriptions of the configurations and functions of the present embodiment identical to those of the first embodiment will be omitted here, and only descriptions of the configurations and functions of the present embodiment different from those of the first embodiment will be given below.

In the step-down chopper circuit, the series circuit of a switch element 31 and a diode 32 are connected in parallel to a smoothing capacitor 23, the switch element 31 being formed of a MOSFET. In the present embodiment, the cathode of the diode 32 is connected to a positive electrode of the smoothing capacitor 23 via the switch element 31. The series circuit of a choke coil 33 and a capacitor 34 are connected in parallel to a diode 32.

With such configuration, when the switch element 31 is turned on, a current flows from the rectifier circuit 22 to the capacitor 34 through the switch element 31 and the choke coil 33, and an energy is accumulated in the choke coil 33 thanks to the current. Thereafter, when the switch element is turned off, current flows from the choke coil 33 through the capacitor 34 and the diode 32, and the energy accumulated in the choke coil 33 is supplied to the capacitor 34. The switch element 31 is repeatedly turned on and off. The repetition period is set to be sufficiently shorter than a time constant which is determined by the inductance of the choke coil 33 and the capacitance of the capacitor 34. Accordingly, a substantially uniform DC voltage is generated between opposite ends of the capacitor 34, and this DC voltage is applied between the terminals Ti and T2 of the lamp 1.

Furthermore, the present embodiment is the same as the embodiment 1 in that the resistor 311 detects the current flowing through the light emitting elements 11, but is different in that the comparator 310 slightly differently performs the comparison of the detected voltage with the reference voltage. That is, the voltage applied between opposite ends of the resistor 311 is directly inputted to the inverting input terminal of the comparator 310, and the detected voltage inputted to the inverting input terminal is increased in proportion to an increase in the current flowing through the light emitting elements 11. Accordingly, when the current flowing through the light emitting elements 11 is increased in order to increase the dimming ratio, it is necessary to set the reference voltage, which will be inputted to the non-inverting input terminal of the comparator 310, to be greater.

Based on the magnitude relationship between the detected voltage of the comparator 310 and a reference voltage, the control circuit 30 varies the output voltage of the lighting circuit 2 by adjusting the on-period of the switch element 31, thereby enabling a desired current to flow through the light emitting elements 11. In greater detail, the control circuit 30, if the detected voltage of the comparator 310 is lower than a reference voltage, increases the determination threshold value of the oscillation control circuit 302 by setting the output from the comparator 310 to a high level, thereby controlling the on-period of the switch element 31 to be increased.

In the present embodiment, the oscillation control circuit 302 determines the on-period of the switch element 31 based on the determination threshold value, as in the first embodiment. However, since, in the present embodiment, the source potential of the switch element 31 is different from the stable potential (i.e., ground potential) of the control circuit 30, a level shifter circuit for providing a drive signal between the gate and source of the switch element 31 is contained in the oscillation control circuit 302. A secondary coil provided in the choke coil 33 provides a power to the control circuit 30 and also detects current flowing through the choke coil 33 by using the oscillation of the choke coil 33.

For example, when the voltage generated in the secondary coil is inputted to the oscillation control circuit 302, the current flowing through the choke coil 33 becomes gradually decreased in the mode in which the switch element 31 is turned off. When this current becomes zero, the polarity of the voltage generated in the secondary coil is reversed. Here, the oscillation control circuit 302 suppresses the switching loss in the switch element 31 by detecting the time at which the polarity is reversed and turning on the switch element 31, thereby improving the efficiency of the lighting device.

As described above, by using the step-down chopper circuit in the lighting device, it is possible to convert the input of the commercial power source 21 into a high-efficiency DC voltage and apply it to the lamp 1.

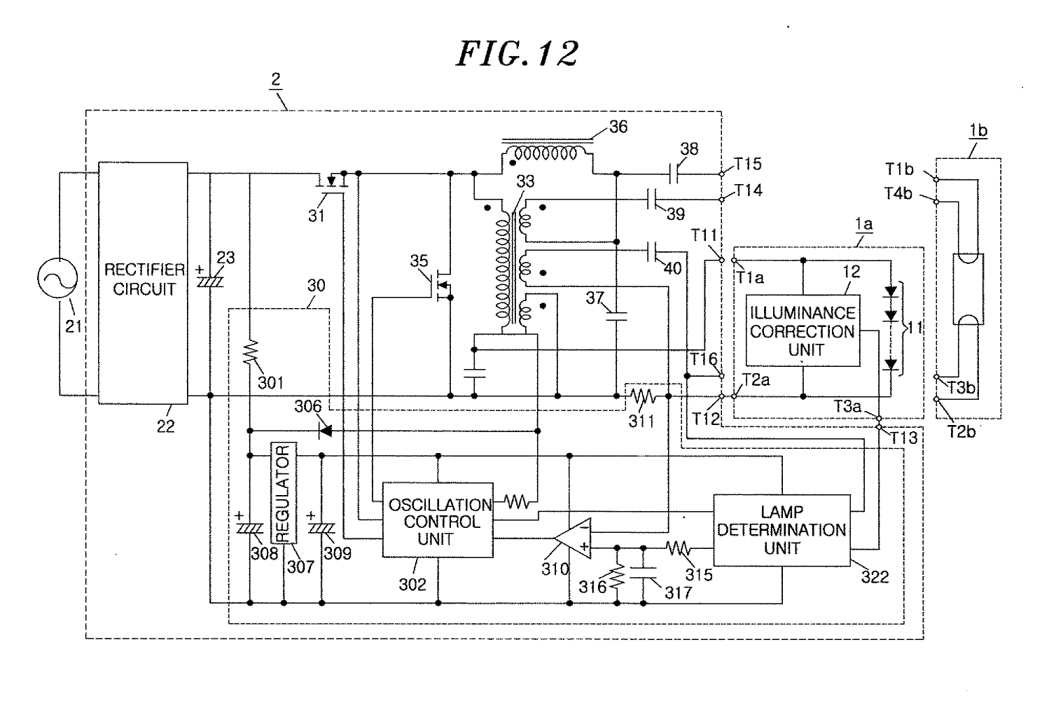

Furthermore, although, in the present embodiment, the illuminance correction unit 12 including the memory 120 and the microcomputer 121 is provided in the lamp 1 and the lamp outputs a PWM signal to the lighting circuit 2, the present embodiment is not limited to this configuration. That is, as shown in FIG. 11, a lamp determination unit 322 which constitutes an illuminance correction unit along with the memory 120 may be provided at the side of the lighting circuit 2, as shown in the configuration of FIG. 9, and a PWM signal may be outputted from the lamp determination unit 322.

Furthermore, in the illumination device of FIG. 11, the lamp determination unit 322 serves as an output stopping unit which directs a lighting device to stop the supply of a power to the lamp 1 when a predetermined time is passed after the cumulative lighting time of the lamp 1 has reached the rated lifespan of the lamp 1.

Specifically, for example, when the illuminance correction control is performed based on illuminance correction characteristics, as shown in FIG. 5, the illuminance correction unit 12 is operated to maintain a dimming ratio of 100% after the cumulative lighting time of the lamp 1 has exceeded the rated life span. This serves to prevent problems, such as the heat emission or breakdown of the lamp 1 or lighting circuit 2, which may be caused because the lighting device needs to supply to the lamp 1 a power higher than the rated power of the lamp 1 if such control is performed such that the luminous flux is uniformly maintained even when the lamp 1 is used beyond the rated life span.

However, electronic parts included in the lamp 1 or lighting circuit 2 have life spans. Accordingly, it is not preferable to use the electronic parts beyond their life spans even though a power below the rated power is used. Accordingly, in order to prevent the electronic parts from being used beyond the life spans, the illumination device shown in FIG. 11 is configured to stop the supply of a power to the lamp 1 or lighting circuit 2 before the life spans of the electronic parts are reached.

In greater detail, the lamp determination unit 322 outputs a stop signal to the oscillation control circuit 302 when the cumulative lighting time read from the memory 120 of the lamp 1 exceeds a predetermined stop time or the counted cumulative lighting time exceeds the stopping time during the lighting of the lamp 1. Here, the term “stopping time” refers to the time obtained by adding a predetermined time to the rated life span of the lamp 1. When receiving the stop signal, the oscillation control circuit 302 stops the switching operation of the switch element 31.

As described above, it is possible to prevent the electronic parts included in the lamp 1 from being used beyond their life spans by providing an instruction (a stop signal) for stopping the supply of an output to the lamp 1 from the output stopping unit to the lighting device when the cumulative lighting time of the lamp 1 exceeds the predetermined stopping time.

Furthermore, the lamp determination unit 322 may count the time for which the lighting circuit 2 has been used, as well as the cumulative lighting time of the lamp 1, and store the counted values in a memory provided in the control circuit 30, e.g., a memory 322-1 provided in the lamp determination unit 322. In this case, even when data related to the cumulative lighting time is reset by the replacement of the lamp 1, the time for which the lighting circuit 2 has been used is continuously counted. Accordingly, it is possible to stop the switching of the switch element 31 depending on the time for which the lighting circuit 2 has been used so that, the electronic parts included in the lighting circuit 2 can be prevented from being used beyond their life spans.

Meanwhile, it is possible to omit the function of stopping the supply of a power to the lamp 1 when a predetermined time has elapsed after the cumulative lighting time of the lamp 1 has reached the rated life span of the lamp 1. In this case, the output route of the stop signal that directly connects the lamp determination unit 322 with the oscillation control circuit 302 may be omitted from the configuration shown in FIG. 11.

The other configurations and functions of the present embodiment are the same as those of the first embodiment.

### Third Embodiment

The illumination device of a third embodiment is different from the illumination device of the second embodiment in that a second lamp 1b including a common fluorescent lamp, as well as a first lamp 1a including light emitting elements (for example, LEDs) 11, can be used together as lamps, as shown in FIG. 12. In the present embodiment, the lamp 1b is formed of a straight, tubular fluorescent lamp, and the lamps 1a and 1b share a common outer appearance.

A basic configuration is common both to the lighting circuit 2 of the present embodiment and the lighting circuit of FIG. 11 described in conjunction with the second embodiment. In the present embodiment, the lighting circuit 2 includes a second switch element 35, formed of a MOSFET, instead of the diode 32 shown in FIG. 11. When the lighting device is operated as a step-down chopper circuit, a parasitic diode (not shown) embedded in the switch element 35 is used as a diode for the step-down chopper circuit by fixing the gate-source of the second switch element 35 to “a low level.”

In the present embodiment, the lighting circuit 2 includes terminals T11, T12 and T13 that are respectively connected to the terminals T1a, T2a and T3a of the lamp 1a. The terminals T1a and T2a of the lamp 1a are connected to opposite ends of the series circuit of the light emitting elements 11 such that the terminal T1a becomes a high potential side, and the terminal T3a thereof is connected to the output of the illuminance correction unit 12. Furthermore, the terminal T11 is connected to the high potential side of a capacitor 34, and the terminal T12 is connected to a low potential side of the capacitor 34 via a resistor 311. The terminal T13 is connected to the lamp determination unit 322.

That is, when the gate-source of the second switch element 35 is fixed to “low level,” the lighting device is operated as a step-down chopper circuit and applies a DC voltage between opposite ends of the capacitor 34 to the lamp 1a and lights the light emitting elements 11, as in the configuration of the second embodiment.

An operation mode in which the lighting circuit 2 lights the first lamp 1a by operating the lighting device as a step-down chopper circuit in the state where the first lamp 1a connected thereto as described above is referred to as “a first operation mode.”

Next, the configuration and operation of the lighting circuit 2 for lighting the second lamp 1b formed of a fluorescent lamp will now be described.

The series circuit of the first switch element 31 and the second switch element 35 is connected in parallel to the smoothing capacitor 23. The second switch element 35, which is a lower part (lower potential side) of the above series circuit, is connected to a resonance circuit including a choke coil 36 and capacitors 37 and 38, included in a so-called half bridge-type inverter circuit. The series circuit of the choke coil 36 and the capacitor 37 is connected in parallel to the second switch element 35.

In the present embodiment, a pair of filaments (electrodes) is provided at opposite ends of the second lamp 1b, and the terminal T1b and a terminal T4b are connected to one filament and the terminals T2b and T3b are connected to the other filament. The lighting circuit 2 has terminals T15, T16 and T14 that are respectively connected to the terminals T1b, T3b and T4b of the second lamp 1b. The terminal T2b of the lamp 1b is connected to the terminal T12 of the lighting circuit 2. Furthermore, the terminal T15 is connected to a junction between the choke coil 36 and the capacitor 37 via the capacitor 38.

The first and second switch elements 31 and 35 are alternately turned on and off by an oscillation control circuit 302, for example, at a frequency of about 50 kHz, and converts a DC voltage, obtained by rectifying input from a commercial power source 21, into a high-frequency square wave voltage. The lighting device lights the lamp 1b by converting this square wave voltage into a sine wave voltage by use of the above-described resonance circuit and applying the sine wave voltage from the terminals T15 and T12 to the lamp 1b.

Furthermore, in order to light the lamp 1b formed of the fluorescent lamp, the two filaments of the lamp 1b are sufficiently heated and, thereafter, a high voltage by which the electric discharge can be performed needs to be applied between the two filaments. Therefore, in order to use the lamp 1b formed of the fluorescent lamp, the lighting device requires a preheating circuit for preheating the filaments.

Accordingly, in the present embodiment, three secondary coils are provided in the choke coil 33 which is included in a step-down chopper circuit, and two of the three secondary coils are respectively connected to the filaments via the capacitors 39 and 40. In greater detail, one end of a first secondary coil is connected to the terminal T14 via the capacitor 39, and the other end thereof is connected to the terminal T15 via the capacitor 38. One end of a second secondary coil is connected to the terminal T16 via the capacitor 40, and the other end thereof is connected to the terminal T12. Accordingly, the terminals T1b, T2b, T3b and T4b of the lamp 1b are respectively connected to the terminals T15, T12, T16 and T14 of the lighting circuit 2, so that the first and the second secondary coil are respectively connected to the filaments.

Accordingly, the lighting device preheats the filaments of the lamp 1b by supplying a preheating current from the secondary coils of the choke coil 33 to the filaments of the lamp 1b through the capacitors 39 and 40 in a preheating mode. In the present embodiment, the lighting device can supply a preheating current appropriate for the lamp 1b by adjusting the coil winding ratio between the primary and secondary coils of the choke coil 33 or the capacitances of capacitors 39 and 40. Furthermore, a third secondary coil of the choke coil 33, other than the secondary coils for preheating, is employed to not only supply a power to a control circuit 30 by using the oscillation of the choke coil 33, but also to detect a current flowing through the choke coil 33.

Furthermore, the lighting device is configured to apply a high voltage to the lamp 1b by using resonance characteristics of a resonance circuit in order to discharge the lamp 1b formed of a fluorescent lamp. That is, the lighting circuit 2 preheats the filaments and immediately makes the operating frequency of an inverter circuit approach the natural frequency (resonance frequency) of the choke coil 36 and the capacitors 37 and 38, thereby entering a start mode and applying a high voltage to the lamp 1b. The lamp 1b starts to be discharged by applying a high voltage between the two preheated filaments. After the starting of the lamp 1b, the lighting circuit 2 switches the operating frequency of the inverter circuit so as to move to a lighting mode in which a predetermined light output can be stably obtained.

The oscillation control circuit 302 switches a frequency in accordance with the above-described preheating, start and lighting modes in order to control the switching of the switch elements 31 and 35 constituting a half bridge circuit. Accordingly, desired preheating current, starting voltage and lighting characteristics can be obtained.

Furthermore, as in the step-down chopper circuit, a level shifter circuit is provided in the oscillation control circuit 302 in order to drive the upper switch element 31. Besides, in order to prevent the two switch elements 31 and 35 from being simultaneously turned on, a delay circuit for outputting an on signal after a predetermined time (a dead time) since one of the switch elements 31 and 35 has been turned off is provided in each drive circuit.

An operation mode in which the lighting circuit 2 lights the second lamp 1b by operating the lighting device as an inverter circuit in the state where the second lamp 1b is connected thereto is referred to as “a second operation mode”. That is, the lighting circuit 2 is configured to switch between the first operation mode in which the connected first lamp 1a is lit and the second operation mode in which the connected second lamp 1b is lit.

Furthermore, the illumination apparatus 50 (see FIG. 6) including the lighting circuit 2 of the present embodiment is configured such that the lamp 1b formed of a common fluorescent lamp as well as the lamp 1a using the light emitting elements 11 are suitably operated.

The above-described illumination device in accordance with the present embodiment can switch between the first operation mode and the second operation mode, thereby enabling not only the first lamp 1a using the light emitting elements 11 but also the second lamp 1b formed of a fluorescent lamp to be used.

In the illumination device, the switch element 31 serving as a constituent part of the step-down chopper circuit (switching power) in the first operation mode is commonly used as a constituent part of the inverter circuit in the second operation mode. Furthermore, the choke coil serving as a constituent part of the step-down chopper circuit in the first operation mode is commonly used as the primary coil of a transformer for preheating in the second operation mode.

As described above, compared to the case where separate switching power sources are used for the respective operation modes, the lighting circuit 2 can reduce the number of parts because some of the elements of the switching power are commonly used in the first and the second operation mode.

In the meantime, the lamp determination unit 322 serves to determine whether the first lamp 1a using the light emitting elements 11 or the second lamp 1b formed of the fluorescent lamp has been connected to the lighting circuit 2.

The lamp determination unit 322 determines whether the first lamp 1a using the light emitting elements 11 has been connected to the lighting circuit 2 depending on whether data related to the cumulative lighting time is read out from the terminal T13. That is, the lamp determination unit 322 determines that the first lamp 1a has been connected when the data related to the cumulative lighting time is read out from the terminal T13.

Meanwhile, the lamp determination unit 322 determines whether the second lamp 1b formed of the fluorescent lamp has been connected to the lighting circuit 2 depending on whether a current flows when a DC bias is applied between the terminals T16 and T12. That is, the lamp determination unit 322 determines that the second lamp 1b has been connected if a current flows when DC bias is applied between the terminals T16 and T12. Furthermore, in order to apply DC bias between the terminals T16 and T12, the lamp determination unit 322 is also connected to the terminal T16.

By identifying the type of lamp as described above, the lamp determination unit 322 can automatically determines weather the lamp 1a using light emitting elements 11 or the lamp 1b formed of the fluorescent lamp has been installed, or all of the lamps have not been installed.

Accordingly, the lamp determination unit 322 outputs determination results to the oscillation control circuit 302 and, therefore, the oscillation control circuit 302 can automatically switch between the first operation mode and the second operation mode depending on the installed load (lamp).

Furthermore, in the illumination apparatus 50, it is required to change the combination of terminals connected to the socket 52 between the combination of terminals T11˜13 and the combination of terminals T12 and T14˜T16 depending on the type of lamp to be installed. Accordingly, the determination results of the lamp determination unit 322 are also outputted to a switch (not shown), and the connection relationship between the socket 52 and the terminals T11-T16 is automatically switched by this switch.

However, in the illumination device of the present embodiment, when the first lamp 1a is used, the illuminance correction control may be performed by the illuminance correction unit 12, provided in the lamp 1a, and/or the lamp determination unit 322. In this case, the illuminance correction control is the same as the illuminance correction control described in conjunction with the first or the second embodiment. After the replacement of the lamp 1a, the cumulative lighting time stored in the memory 120 can be reset, and the dimming ratio, that is, the illuminance correction value, can be restored to an initial value.

Meanwhile, in the illumination device, when the second lamp 1b formed of the fluorescent lamp is used, the illuminance correction control can be performed by using the lamp determination unit 322. When the illuminance correction control of the lamp 1b is performed, the lamp determination unit 322 includes a memory (not shown) for storing illuminance correction characteristics based on the luminous flux decline characteristics of the fluorescent lamp and counts the cumulative lighting time of the lamp 1b. Accordingly, when the lamp 1b formed of the fluorescent lamp is used, the lamp determination unit 322 can perform the illuminance correction control based on the luminous flux decline characteristics of the lamp 1b.

Although the present embodiment has illustrated and described the example in which the configuration of the second embodiment is adopted as its basic configuration and the lamp 1b formed of the common fluorescent lamp, as well as the lamp 1a using the light emitting elements 11, is used together as appropriate lamps, the present invention is not limited thereto. That is, the configuration of the first embodiment may be adopted as a basic configuration. The other configurations and functions are the same as those of the second embodiment.

While the invention has been shown and described with respect to the embodiments, it will be understood by those skilled in the art that various changes and modifications may be made without departing from the scope of the invention as defined in the following claims.

What is claimed is:

1. An illumination device comprising:
a replaceable lamp including at least one light emitting element;
a lighting device for lighting the light emitting element by supplying a power to the lamp; and
an illuminance correction unit for performing a dimming control on the lamp,
wherein the illuminance correction unit includes a timer for counting a cumulative lighting time of the light emitting element and a memory for storing the cumulative lighting time counted by the timer,
wherein the illuminance correction unit determines a dimming ratio of the light emitting element based on the cumulative lighting time stored in the memory and an illuminance correction characteristic, in which the relationship between the cumulative lighting time and the dimming ratio of the light emitting element is determined to uniformly maintain a light output from the light emitting element even when the cumulative lighting time of the light emitting element increases, and
wherein the memory is provided in the lamp.

2. The illumination device of claim 1, wherein the timer is provided in the lamp.

3. The illumination device of claim 1, wherein the illuminance correction unit includes an output stopping unit which provides an instruction to the lighting device to stop supplying the power to the lamp when the cumulative lighting time of the light emitting element exceeds a threshold.

4. The illumination device of claim 1, wherein the illuminance correction unit includes a temperature measurement unit for measuring a surrounding temperature of the lamp, and determines the illuminance correction characteristic depending on the surrounding temperature measured by the temperature measurement unit.

5. The illumination device of claim 1, wherein the lighting device includes a flyback converter and applies an output voltage of the flyback converter to the lamp.

6. The illumination device of claim 1, wherein the lighting device includes a step-down chopper circuit and applies an output voltage of the step-down chopper circuit to the lamp.

7. A lamp for use with the illumination device set forth in claim 1.

8. A lighting circuit included in the illumination device set forth in claim 1 along with the lamp set forth in claim 7,
wherein the lighting circuit comprises a switching power source and is configured to switch between a first operation mode in which a connected first lamp formed of the lamp set forth in claim 7 is lit and a second operation mode in which a connected second lamp formed of a fluorescent lamp is lit, and parts of elements of the switching power source are commonly used both in the first operation mode and in the second operation mode.

9. An illumination apparatus comprising
the lighting circuit set forth in claim 8,
wherein both of the first lamp and the second lamp are usable with the illuminance apparatus.
